(19) United States
(12) Patent Application Publication
(10) Pub. No.: US 2020/0409219 A1
(43) Pub. Date: Dec. 31, 2020

(54) DISPLAY APPARATUS

(71) Applicant: SAKAI DISPLAY PRODUCTS CORPORATION, Osaka (JP)

(72) Inventors: DAISUKE TERAGAWA, Osaka (JP); TOMOHIRO ASAMIZU, Osaka (JP); NORIAKI MIYOSHI, Osaka (JP)

(21) Appl. No.: 16/890,538

(22) Filed: Jun. 2, 2020

Related U.S. Application Data
(60) Provisional application No. 62/868,335, filed on Jun. 28, 2019.

(51) Int. Cl. G02F 1/13357; F21V 8/00; G02F 1/1335

(52) U.S. Cl. CPC G02F 1/133606; G02F 1/133524; G02B 6/0051

(57) ABSTRACT

A display apparatus includes a light source, a diffusion plate, a display panel, and a scattering member. The light source emits light. The diffusion plate diffuses the light emitted from the light source. The display panel has a display area. The diffusion plate and the display panel are spaced away. The scattering member is located between the display panel and the diffusion plate with the scattering member located nearer the diffusion plate than the display panel. The diffusion plate has a first incidence surface and a first exit surface. The first incidence surface allows the light emitted from the light source to be incident thereon. The first exit surface is smaller than the display area. The diffusion plate allows the light entered from the first incidence surface to exit from the first exit surface with the light diffused. The scattering member allows the light exited from the first exit surface to pass therethrough with the light passing therethrough scattered.

### INCORPORATION BY REFERENCE

The present application claims benefit of priority to U.S. Provisional Patent Application No. 62/868,335, filed on Jun. 28, 2019. The contents of this application are incorporated herein by reference in its entirety.

### BACKGROUND

The present disclosure relates to a display apparatus.

The display apparatus display apparatus includes a light source and a display panel. The display panel displays an image by receiving light from a point light source or a surface light source and guided thereto.

In display apparatuses developed in recent years, a frame width thereof is narrowed by a narrow frame design. However, in a display apparatus according to the narrow frame design, the light emitted from the light source is less likely to reach part of the display apparatus outside the light source, such as part of the display apparatus adjacent to edges of a display area thereof. This may cause occurrence of dark portions near the edges of the display area, for example.

### SUMMARY

A display apparatus according to an aspect of the present disclosure includes a light source, a diffusion plate, a display panel, and a scattering member. The light source emits light. The diffusion plate diffuses the light emitted from the light source. The display panel has a display area. The display panel and the diffusion plate are spaced apart. The scattering member is located between the display panel and the diffusion plate with the scattering member located nearer the diffusion plate than the display panel. The diffusion plate has a first incidence surface and a first exit surface. The first incidence surface allows the light emitted from the light source to be incident thereon. The first exit surface is smaller than the display area. The diffusion plate allows the light entered from the first incidence surface to exit from the first exit surface with the light diffused. The scattering member allows the light exited from the first exit surface to pass therethrough with the light passing therethrough scattered.

A display apparatus according to an aspect of the present disclosure includes a light source, a light guide plate, a display panel, and a scattering member. The light source emits light. The light guide plate guides the light emitted from the light source. The display panel has a display area. The display panel and the light guide plate are spaced apart. The scattering member is located between the display panel and the light guide plate with the scattering member located nearer the light guide plate than the display panel. The light guide plate has a light-guide incidence surface and a light-guide exit surface. The light-guide incidence surface is an incidence surface of the light guide plate and allows the light emitted from the light source to be incident thereon. The light-guide exit surface is an exit surface of the light guide plate and is smaller than the display area. The light guide plate allows the light entered from the light-guide incidence surface to exit from the light-guide exit surface. The scattering member allows the light exited from the light-guide exit surface to pass therethrough with the light passing therethrough scattered.

### BRIEF DESCRIPTION OF THE DRAWINGS

FIG. 1 illustrates a structure of a display apparatus according to a first embodiment.

FIG. 2A is a schematic diagram of main parts of the display apparatus according to the first embodiment.

FIG. 2B is an enlarged view in the vicinity of a scattering sheet illustrated in FIG. 2A.

FIG. 3 is a perspective view of part of the scattering sheet in the first embodiment.

FIG. 4A is a schematic perspective view of a first projection illustrated in FIG. 3.

FIG. 4B is a schematic plan view of the first projection illustrated in FIG. 3.

FIG. 4C is a schematic side view of the first projection illustrated in FIG. 3.

FIG. 5A is a plan view of the scattering sheet in the first embodiment.

FIG. 5B is a sectional view of the scattering sheet taken along a line VB-VB of FIG. 5A.

FIG. 6 illustrates a first additional example of the scattering sheet in the first embodiment.

FIG. 7 illustrates a second additional example of the scattering sheet in the first embodiment.

FIG. 8A is a plan view of a scattering sheet in a display apparatus according to a second embodiment.

FIG. 8B is a sectional view of the scattering sheet taken along a line VIIIB-VIIIB of FIG. 8A.

FIG. 9 illustrates an additional example of the scattering sheet in the second embodiment.

FIG. 10A is a perspective view of an example of a first sheet in a display apparatus according to a third embodiment.

FIG. 10B is a side view of a first sheet projection illustrated in FIG. 10A.

FIG. 11A illustrates an example of a second sheet in a display apparatus according to the third embodiment.

FIG. 11B is a side view of a second sheet projection illustrated in FIG. 11A.

FIG. 12A is a schematic diagram of main parts of a display apparatus according to a fourth embodiment.

FIG. 12B is an enlarged view in the vicinity of a light collecting sheet illustrated in FIG. 12A.

FIG. 13 is a perspective view of part of the light collecting sheet in the fourth embodiment.

FIG. 14A is a perspective view of a first additional example of the light collecting sheet in the fourth embodiment.

FIG. 14B is a perspective view of a second additional example of the light collecting sheet in the fourth embodiment.

FIG. 14C is a perspective view of a third additional example of the light collecting sheet in the fourth embodiment.

FIG. 15 is a schematic diagram of main parts of a display apparatus according to a fifth embodiment.

### DETAILED DESCRIPTION

Embodiments of a display apparatus according to the present disclosure will hereinafter be described with reference to the accompanying drawings. The present disclosure is however not limited to the embodiments below. Note that an X direction, a Y direction, and a Z direction that are orthogonal to one another may be described in the specification of the present application in order to facilitate understanding of the disclosure. Typically, the X and Y directions are parallel to a horizontal direction, while the Z direction is parallel to a vertical direction.

### First Embodiment

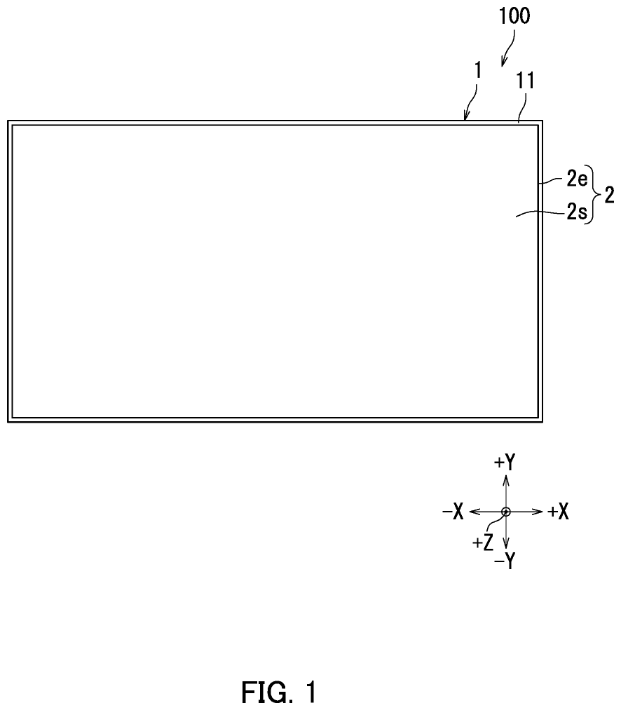

A configuration of a display apparatus 100 according to a first embodiment will first be described with reference to FIG. 1. FIG. 1 illustrates a structure of the display apparatus 100 according to the first embodiment. The display apparatus 100 according to the present embodiment is a liquid-crystal display.

As illustrated in FIG. 1, the display apparatus 100 includes a housing 1 and a display panel 2. The housing 1 supports the display panel 2. The housing 1 includes a frame 11. The frame 11 surrounds the display panel 2.

The display panel 2 has a display area 2s that is rectangular and displays an image. The display area 2s is formed in a surface (display surface) exposed from the frame 11 within the display panel 2. Edges 2e of the display area 2s may hereinafter be referred to simply as “edges 2e”. Note that although the edges 2e of the display area 2s coincide with inner edges of the frame 11 in the present embodiment, the edges 2e may be located inside, away from the inner edges of the frame 11. In the present embodiment, a normal direction to the display surface coincides with the Z direction. In the present embodiment, a lengthwise direction of the display surface coincides with the X direction, while a widthwise direction of the display surface coincides with the Y direction.

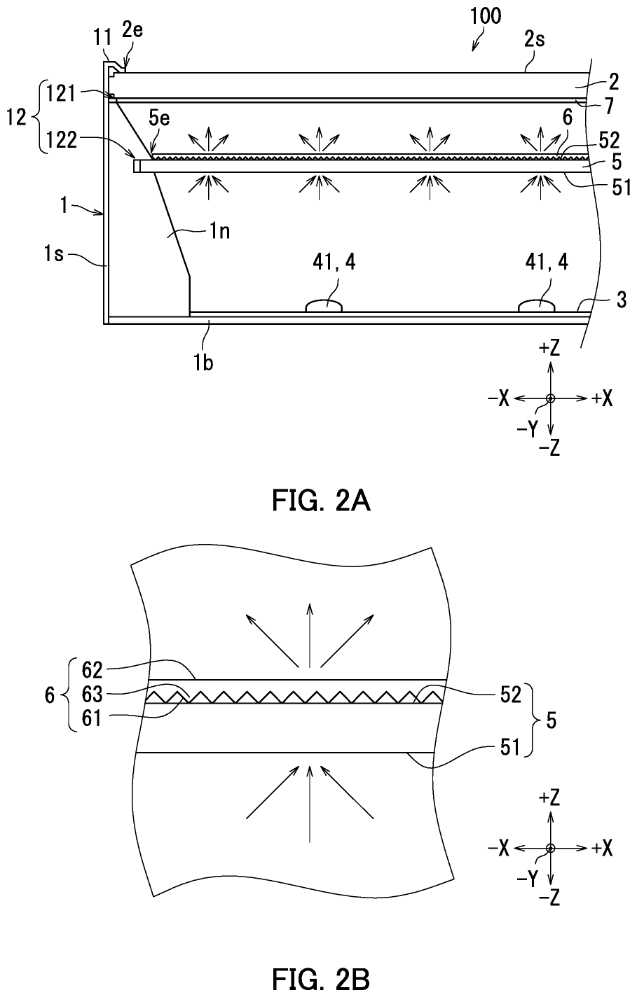

A structure, in the vicinity of an edge 2e of the display apparatus 100 according to the first embodiment will next be described with reference to FIG. 2A. Note that the structure in the vicinity of the edge 2e on the −X side of the display apparatus 100 is the same as each of a structure in the vicinity of an edge 2e on the +X side thereof, a structure in the vicinity of an edge 2e on the −Y side thereof, and a structure in the vicinity of an edge 2e on the +Y side thereof. Accordingly, although the structure in the vicinity of the edge 2e on the −X side of the display apparatus 100 will be described with reference to FIG. 2A, the description of the structure in the vicinity of the edge 2e on the +X side, the structure in the vicinity of the edge 2e on the −Y side, and the structure in the vicinity of the edge 2e on the +Y side will be omitted.

FIG. 2A is a schematic diagram of main parts of the display apparatus 100 according to the first embodiment. Specifically, FIG. 2A is a sectional view in the vicinity of the edge 2e on the −X side of the display apparatus 100, as viewed from the −Y side. Note that in FIG. 2A, hatching indicating a cross section of the display apparatus 100 is omitted for easy understanding. Each of arrows depicted in FIG. 2A represents part of a beam of light.

As illustrated in FIG. 2A, the display apparatus 100 is a direct backlight display. In addition to the housing 1 and the display panel 2, the display apparatus 100 includes a reflector 3, a light source section 4, a diffusion plate 5, a scattering sheet 6, and an optical sheet 7. The housing 1 accommodates the reflector 3, the light source section 4, the diffusion plate 5, the scattering sheet 6, and the optical sheet 7. The reflector 3, the light source section 4, the diffusion plate 5, the scattering sheet 6, the optical sheet 7, and the display panel 2 are arranged in this order from a back side (−Z side) to a front side (+Z side) of the display apparatus 100. Note that the scattering sheet 6 is one example of a scattering member.

The housing 1 includes a bottom wall 1b and inner walls 1n. The bottom wall 1b forms a bottom of the housing 1. The inner walls 1n protrude inside the housing 1 from side walls is of the housing 1. The inner walls 1n are inclined outside the housing 1 relative to a direction from the bottom wall 1b to the display panel 2. In the present embodiment, each of the inner walls 1n is a white wall. Alternatively, a reflective member is applied to each of the inner walls 1n.

The housing 1 further includes a support 12. In the present embodiment, the support 12 includes a first support portion 121 and a second support portion 122. Within the housing 1, the second support portion 122 is provided on the −Z side relative to the first support portion 121 (lower side of the first support portion 121) and on the +X side relative to the first support portion 121 (inside the first support portion 121).

The first support portion 121 supports the display panel 2. Specifically, for example a gap between an end face (upper end face) on the +Z side of an inner wall 1n and the frame 11 functions as the first support portion 121. The display panel 2 is supported by the first support portion 121 as a result of an end on the −X side of the display panel 2 being fitted between the end face (upper end face) on the +Z side and the frame 11.

The second support portion 122 supports the diffusion plate 5. Specifically, for example a cut formed in the inner wall 1n functions as the second support portion 122. The diffusion plate 5 is supported by the second support portion 122 as a result of an end on the −X side of the diffusion plate 5 being fitted in the cut. Of the diffusion plate 5, a portion except part fitted in the second support portion 122 may hereinafter be referred to as an “exposed portion”.

The display panel 2 is a liquid-crystal display panel. The display panel 2 includes a liquid-crystal device, a color filter substrate, a thin film transistor (TFT) substrate, and a polarizer. The liquid-crystal device is arranged between the color filter substrate and the TFT substrate. The color filter substrate includes a glass substrate and color resist with which the glass substrate is coated. The TFT substrate includes a thin film transistor per pixel. The polarizer allows light polarized in a specific direction to pass therethrough.

The reflector 3 is located on the bottom wall 1b of the housing 1. Component examples of the reflector 3 include a reflective sheet and a member coated with reflective material. The light source section 4 is located on the reflector 3.

The light source section 4 emits light. The light emitted from the light source section 4 is incident on the diffusion plate 5. Note that part of the light emitted from the light source section 4 is reflected by the reflector 3 to be incident on the diffusion plate 5. In the present embodiment, the light source section 4 includes first light sources 41. The first light sources 41 include for example light-emitting diodes (LEDs). The LEDs are arranged in the X and Y directions.

The diffusion plate 5 diffuses the light emitted from the light source section 4. The diffusion plate 5 and the display panel 2 are spaced apart. An external shape of the diffusion plate 5 corresponds to an external shape of the display panel 2. In the present embodiment, the diffusion plate 5 is rectangular in plan view.

External dimensions of the diffusion plate 5 (external dimensions of the exposed portion thereof) are smaller than external dimensions of the display panel 2 (display area 2s). Specifically, a length of the diffusion plate 5 (exposed portion thereof) in the X direction is smaller by a first distance than a length of the display area 2s in the X direction. The first distance is for example a sum of a distance x1 and a distance x2. The distance x1 is a distance in the X direction between the edge 2e on the −X side of the display area 2s and an edge 5e on the −X side of the exposed portion of the diffusion plate 5. The distance x2 is a distance in the X direction between the edge 2e on the +X side of the display area 2s and an edge 5e on the +X side of the exposed portion of the diffusion plate 5. The distance x1 may be equal to or different from the distance x2. The edges 5e of the exposed portion of the diffusion plate 5 represent a boundary between the diffusion plate 5 and the second support portion 122. The first distance is for example 8 mm.

A length of the diffusion plate 5 (exposed portion thereof) in the Y direction is smaller by a second distance than a length of the display area 2s in the Y direction. The second distance is for example a sum of a distance y1 and a distance y2. The distance y1 is a distance between the edge 2e on the −Y side of the display area 2s and an edge 5e on the −Y side of the exposed portion of the diffusion plate 5. The distance y2 is a distance between the edge 2e on the +Y side of the display area 2s and an edge 5e on the +Y side of the exposed portion of the diffusion plate 5. The distance y1 may be equal to or different from the distance y2. The second distance is for example 8 mm. Note that the second distance may be equal to or different from the first distance.

The diffusion plate 5 has a first incidence surface 51 and a first exit surface 52. The first incidence surface 51 allows the light emitted from the light source section 4 to be incident thereon. The first incidence surface 51 corresponds to a main surface (back surface) of the diffusion plate 5 on a side of the light source section 4 (−Z side—back side).

The diffusion plate 5 allows the light entered from the first incidence surface 51 to exit from the first exit surface 52 with the light diffused. The first exit surface 52 corresponds to a main surface (front surface) of the diffusion plate 5 on a side of the display panel 2 (+Z side-front side). As described above, the external dimensions of the diffusion plate 5 are smaller than the external dimensions of the display area 2s of the display panel 2. External dimensions of the first exit surface 52 are therefore smaller than external dimensions of the display area 2s.

The scattering sheet 6 is located between the optical sheet 7 and the diffusion plate 5. In other words, the scattering sheet 6 is located between the display panel 2 and the diffusion plate 5. Specifically, the scattering sheet 6 is located nearer the diffusion plate 5 than the display panel 2 in the Z direction. In the present embodiment, the scattering sheet 6 is disposed on the diffusion plate 5. Note that an air layer is provided between the diffusion plate 5 and the scattering sheet 6.

The main surface (back surface) of the scattering sheet 6 on the side of the diffusion plate 5 (−Z side—back side) is uneven. The scattering sheet 6 is for example a lens sheet. A refractive index of the scattering sheet 6 is higher than a refractive index of the air layer. The refractive index of the scattering sheet 6 is for example “1.4”, and the refractive index of the air layer is for example “1.0”.

The scattering sheet 6 allows the light diffused by the diffusion plate 5 to pass therethrough with the light passing therethrough scattered. Note that part of the light scattered by the scattering sheet 6 is reflected by for example the inner walls 1n. This allows light from the outside of the scattering sheet 6 to be incident on the optical sheet 7.

The optical sheet 7 is located directly beneath the display panel 2. The optical sheet 7 collects the light scattered by the scattering sheet 6 to guide the collected light to the display panel 2. A main surface (front surface) of the optical sheet 7 on a side of the display panel 2 (+Z side—front side) is uneven. The optical sheet 7 is for example a lens sheet.

A structure of the scattering sheet 6 in the first embodiment will next be described with reference to FIG. 2B. FIG. 2B is an enlarged view in the vicinity of the scattering sheet 6 illustrated in FIG. 2A. Note that each of arrows depicted in FIG. 2B represents part of a beam of light for easy understanding.

As illustrated in FIG. 2B, the scattering sheet 6 has a second incidence surface 61 and a second exit surface 62. The second incidence surface 61 allows the light exiting the first exit surface 52 to be incident thereon. The scattering sheet 6 allows the light entered from the second incidence surface 61 to exit from the second exit surface 62 with the light scattered.

The second incidence surface 61 has first projections 63. The first projections 63 are one example of projections in the present disclosure. Each of the first projections 63 allows light entered from the second incidence surface 61 to exit with the light refracted. Accordingly, the light exiting the first exit surface 52 is scattered.

As stated above, the light emitted from the light source section 4 is diffused by the diffusion plate 5 and scattered by the scattering sheet 6. This enables an increase in luminous flux of light incident on part, adjacent to the edges 2e, of a back surface of the display panel 2. The embodiment consequently prevents a reduction in luminance near the edges 2e of the display area 2s. Thus, the embodiment prevents occurrence of dark portions near the edges 2e of the display area 2s.

For example, when display apparatuses 100 are arranged to be used as a multi monitor, it may be felt that four corners of a display apparatus 100 surrounded by adjoining display apparatuses 100 are dark. The above structure of the display apparatus 100 however prevents a reduction in luminance at the edges 2e of the display area 2s. Therefore, the embodiment suppresses, even when display apparatuses 100 are used as a multi monitor, dark feeling at four corners of a display apparatus 100 surrounded by adjoining display apparatuses 100.

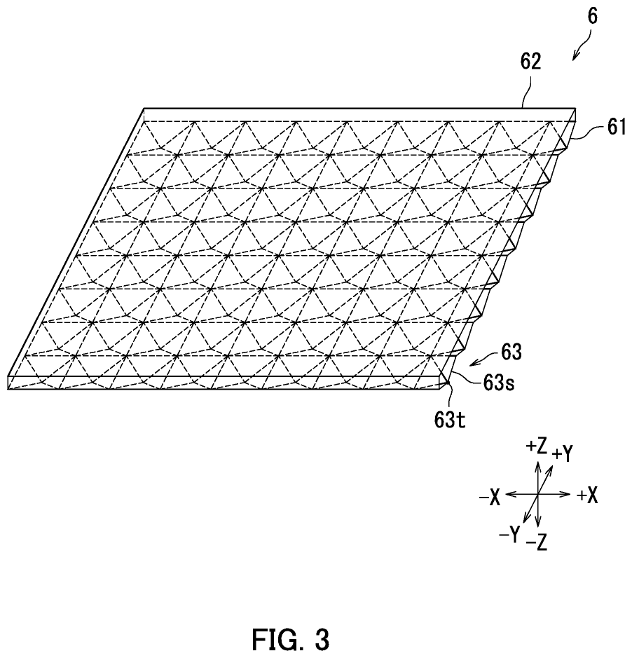

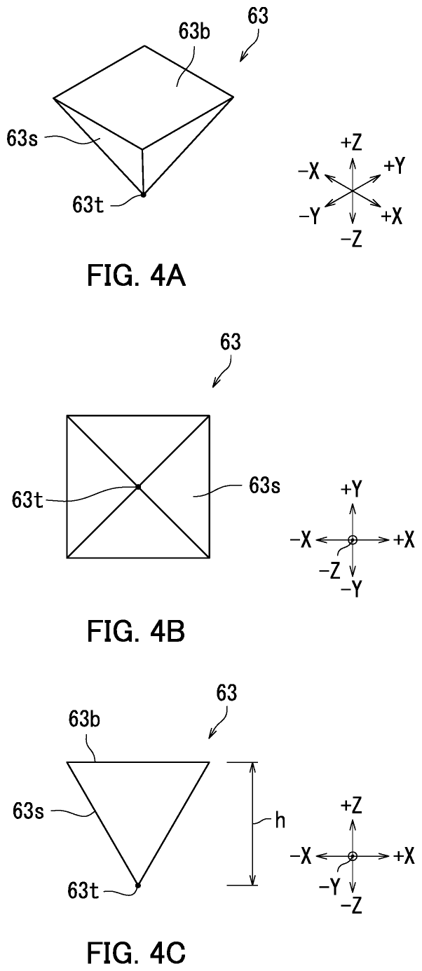

The structure of the scattering sheet 6 in the first embodiment will next be described with reference to FIGS. 3 to 5B. FIG. 3 is a perspective view of part of the scattering sheet 6 in the first embodiment. Specifically, FIG. 3 depicts the scattering sheet 6 cut in the Y direction. Note that hatching indicating a cross section of the scattering sheet 6 is omitted in FIG. 3. FIG. 4A is a schematic perspective view of a first projection 63 illustrated in FIG. 3. FIG. 4B is a schematic plan view of the first projection 63 illustrated in FIG. 3. Specifically, FIG. 4B depicts the first projection 63 viewed from the −Z side. FIG. 4C is a schematic side view of the first projection 63 illustrated in FIG. 3.

As illustrated in FIG. 3, the first projections 63 are regularly arranged on the second incidence surface 61 of the scattering sheet 6.

As illustrated in FIGS. 4A to 4C, the first projection 63 is quadrangular pyramidal in shape. In the present embodiment, the first projections 63 are regular square pyramidal in shape. Specifically, each first projection 63 has a bottom face 63b and side faces 63s that constitute the first projection 63. Here, the bottom face 63b is square, and each of the side faces 63s is equilateral triangle. That is, when the first projection 63 that is a quadrangular pyramid is viewed in plan, a vertex 63t of the first projection 63 is at a center of the quadrangular pyramid. A location of the center of the quadrangular pyramid when the quadrangular pyramid is viewed in plan corresponds to an intersection of two diagonals of the bottom face 63b. A location of the vertex 63t relative to the center of the quadrangular pyramid when the quadrangular pyramid is viewed in plan may hereinafter be referred to as a “relative location”.

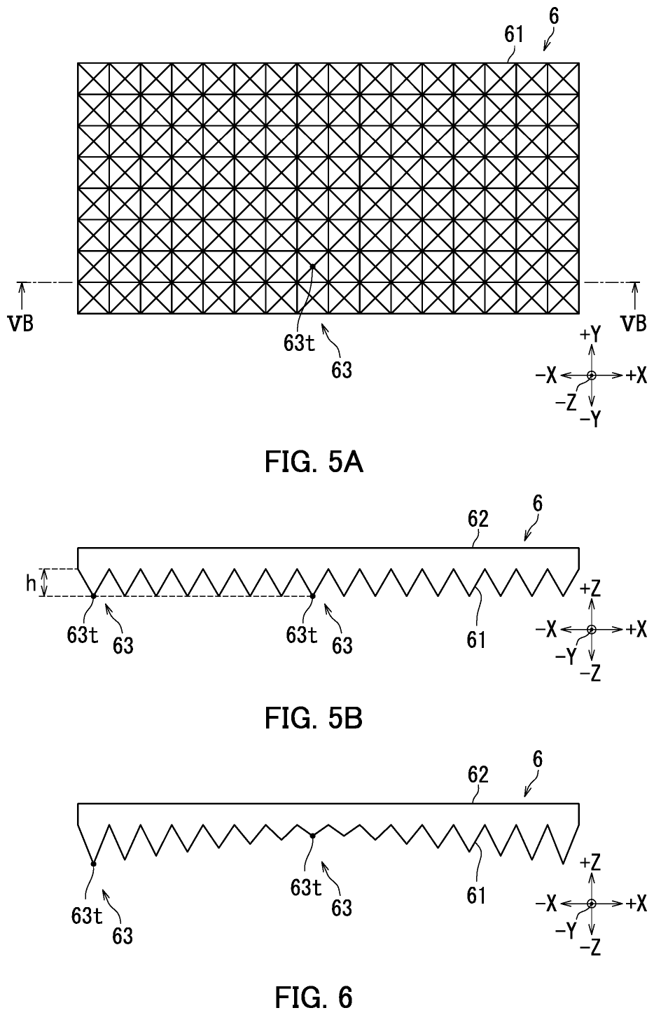

FIG. 5A is a plan view of the scattering sheet 6 in the first embodiment. Specifically, FIG. 5A depicts the scattering sheet 6 viewed from the −Z side. FIG. 5B is a sectional view of the scattering sheet 6 taken along a line VB-VB of FIG. 5A. Note that hatching indicating a cross section of the scattering sheet 6 is omitted in FIG. 5B.

As illustrated in FIGS. 3 to 5B, the first projections 63 are regularly formed on the second incidence surface 61. Specifically, the first projections 63 having the same shape are arranged at regular intervals. In addition, respective orientations of the first projections 63 are constant. Specifically, triangular side faces 63s in each of the first projections 63 intersect with the X direction and the Y direction. The light entered from the second incidence surface 61 is therefore scattered in all directions by the first projections 63.

As illustrated in FIG. 5B, the first projections 63 are identical in height (h). Here, the height h of each first projection 63 corresponds to a distance from the bottom face 63b to the vertex 63t thereof (see FIG. 4C). Light entered from the second incidence surface 61 is therefore scattered uniformly by each first projection 63.

As described above with reference to FIGS. 3 to 5B, the first projections 63 are quadrangular pyramidal. The structure therefore enables the first projections 63 to scatter the light entered from the second incidence surface 61 in all directions. It is accordingly possible to increase luminous flux of light incident on part, adjacent to the edges 2e, of the back surface of the display panel 2. Thus, the embodiment prevents occurrence of dark portions near the edges 2e of the display area 2s.

In addition, regular formation of the first projections 63 on the second incidence surface 61 enables the scattering sheet 6 to uniformly scatter the light. It is consequently possible to uniform luminance distribution of the display panel 2.

Note that although the first projections 63 described above are identical in height (h), respective heights h of the first projections 63 are not necessarily identical. FIG. 6 illustrates a first additional example of the scattering sheet 6 in the first embodiment. As illustrated in FIG. 6, the respective heights h of the first projections 63 may be increased from a center to a periphery of the scattering sheet 6. The respective heights h of the first projections 63 may be increased at a constant rate. Alternatively, the respective heights h of the first projections 63 may be increased at random. Adjusting the respective heights h of the first projections 63 enables adjustment of light scattering directions.

Although the first projections 63 are arranged at regular intervals, the first projections 63 are not necessarily arranged at regular intervals. For example, respective intervals of the first projections 63 may be partially increased and decreased. Adjusting the respective intervals of the first projections 63 enables adjustment of light scattering directions.

Although the respective orientations of the first projections 63 are constant, the respective orientations of the first projections 63 are not necessarily constant. Changing the respective orientations of the first projections 63 enables adjustment of light scattering directions.

Although the triangular side faces 63s in each of the first projections 63 that are quadrangular pyramidal intersect with the X direction and the Y direction, respective orientations of the first projections 63 are not limited to this. For example, the first projections 63 may be rotated at 45 degrees relative to the orientations illustrated in FIG. 5A.

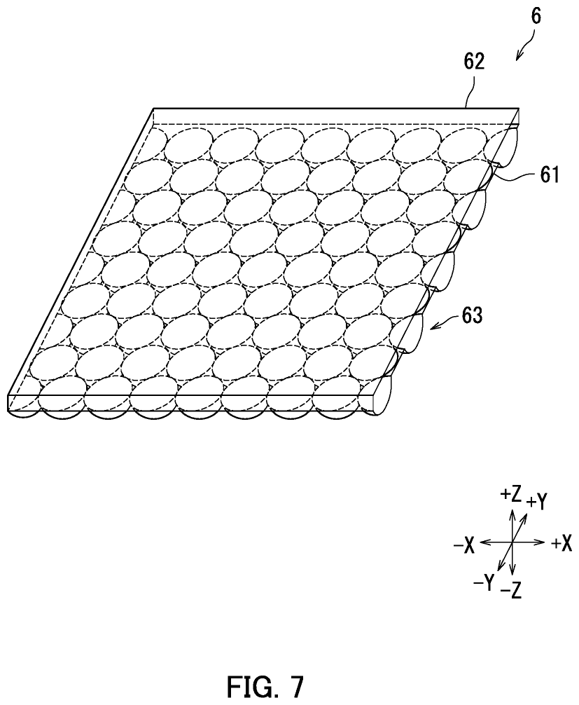

Although the first projections 63 described above are quadrangular pyramidal in shape, the first projections 63 may be triangular pyramidal or hexagonal pyramidal. Alternatively, the first projections 63 may be hemispherical in shape as illustrated in FIG. 7. FIG. 7 illustrates a second additional example of the scattering sheet 6 in the first embodiment. Specifically, FIG. 7 depicts the scattering sheet 6 cut in the Y direction. Note that in FIG. 7, hatching indicating a cross section of the scattering sheet 6 is omitted for easy understanding. The first projections 63 being hemispherical in shape enables the scattering sheet 6 to uniformly scatter light. It is therefore possible to uniform luminance distribution of the display panel 2.

Although the first projections 63 described above are regular square pyramidal in shape, the first projections 63 are not limited to being regular square pyramidal in shape. The first projections 63 may be a quadrangular pyramid, such as a quadrangular pyramid whose bottom face 63b is rectangular in shape or a quadrangular pyramid (oblique square pyramid) whose at least two sides are different in length.

Although the first projections 63 are identical in shape, the first projection 63 may differ in shape. When the first projections 63 differ in shape, the first projection 63 may be formed so that respective relative locations of the vertexes 63t are arranged at random. This structure enables prevention of moire occurrence.

### Second Embodiment

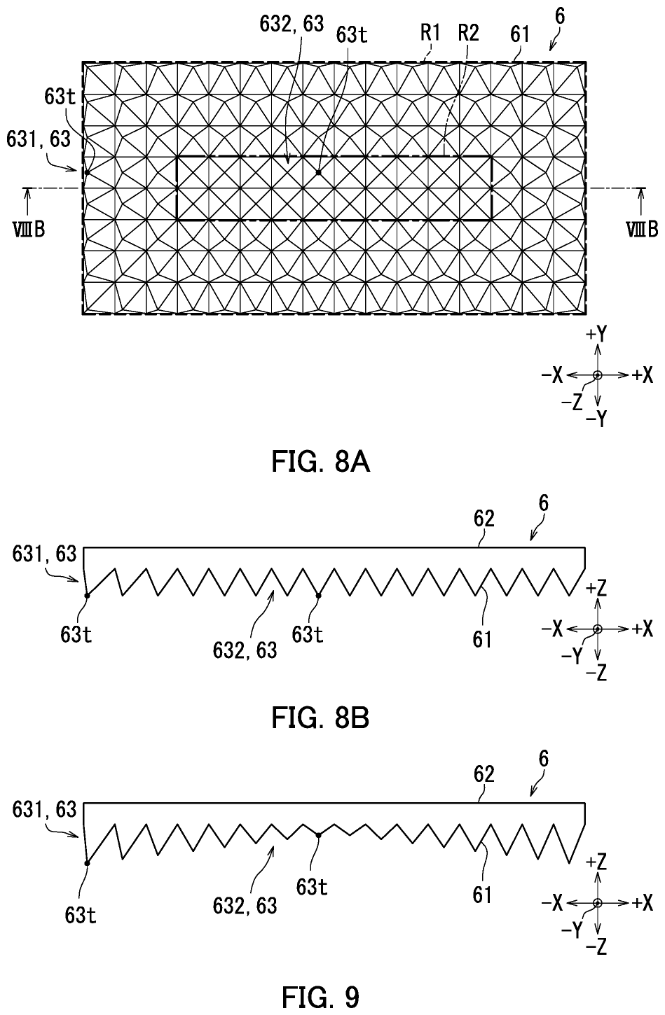

A display apparatus 100 according to a second embodiment will next be described with reference to FIGS. 8A and 8B. The second embodiment is different in a structure of a scattering sheet 6 from the first embodiment. Elements different from those in the first embodiment will hereinafter be described in the second embodiment, and description overlapping with the first embodiment will be omitted.

FIG. 8A is a plan view of the scattering sheet 6 in the second embodiment. Specifically, FIG. 8A depicts the scattering sheet 6 viewed from the −Z side. FIG. 8B is a sectional view of the scattering sheet 6 taken along a line VIIIB-VIIIB of FIG. 8A. Note that hatching indicating a cross section of the scattering sheet 6 is omitted in FIG. 8B.

As illustrated in FIG. 8A, a second incidence surface 61 has a first region R1 and a second region R2.

The first region R1 is a region of an outer portion of the scattering sheet 6. Specifically, the first region R1 is a region between a location of edges of the scattering sheet 6 and a location away from the edges by a specified distance in a center direction. The specified distance is determined according to for example a size of a display panel 2. The second region R2 is a region that is different from the first region R1 of a whole region of the second incidence surface 61. The second region R2 faces a center portion of the display panel 2.

Part of first projections 63 are formed on the first region R1. Of the first projections 63, projections 63 other than first projections 63 formed on the first region R1 are formed on the second region R2. Hereinafter, the first projections 63 formed on the first region R1 are referred to “first region projections 631”, and the first projections 63 formed on the second region R2 are referred to “second region projections 632”.

As illustrated in FIGS. 8A and 8B, the first region projections 631 and the second region projections 632 are regularly arranged. In the present embodiment, each of the second region projections 632 is regular square pyramid in shape, and relative locations of the vertexes 63t of the second region projections 632 are identical among them. Note that the first region projections 631 and the second region projections 632 are identical in height (h) as illustrated in FIG. 8B.

The first region projections 631 are oblique square pyramidal in shape, and relative locations of vertexes 63t of the first region projections 631 are different among them. Specifically, a relative location of a vertex 63t of each first region projection 631 varies according to a corresponding distance from the edges of the scattering sheet 6 to the first region projection 631. More specifically, of the first region projections 631, a vertex 63t of a first region projection 631 near an edge of the scattering sheet 6 is located further away from a center of the first region projection 631 toward the edge of the scattering sheet 6 than another first region projection 631 near a center portion of the scattering sheet 6 when viewed from a direction perpendicular to the second incidence surface 61.

In the example of FIGS. 8A and 8B, of first region projections 631 on a side of one end (e.g., −X side) of the scattering sheet 6 relative to the center portion of the scattering sheet 6, a vertex 63t of a first region projection 631 nearer the one end of the scattering sheet 6 is located further away from a center of the first region projection 631 to the side of the one end of the scattering sheet 6, when viewed from the direction perpendicular to the second incidence surface 61. In other words, of the first region projections 631 on the side of the one end of the scattering sheet 6 relative to the center portion of the scattering sheet 6, their respective vertexes 63t are located nearer the one end of the scattering sheet 6 than their respective centers, and a distance from a center to a vertex 63t of a first region projection 631 nearer the one end of the scattering sheet 6 is larger, when viewed from the direction perpendicular to the second incidence surface 61.

In the example of FIGS. 8A and 8B, of first region projections 631 on a side of the other end (e.g., +X side) of the scattering sheet 6 relative to the center portion of the scattering sheet 6, a vertex 63t of a first region projection 631 nearer the other end of the scattering sheet 6 is located further away from a center of the first region projection 631 to the side of the other end of the scattering sheet 6, when viewed from the direction perpendicular to the second incidence surface 61. In other words, of the first region projections 631 on the side of the other end of the scattering sheet 6 relative to the center portion of the scattering sheet 6, their respective vertexes 63t are located nearer the other end of the scattering sheet 6 than their respective centers, and a distance from a center to a vertex 63t of a first region projection 631 nearer the other end of the scattering sheet 6 is larger, when viewed from the direction perpendicular to the second incidence surface 61.

As above, the second embodiment has been described. In the second embodiment, of the first region projections 631, a vertex 63t of a first region projection 631 near an edge of the scattering sheet 6 is located further away from a center of the first region projection 631 toward the edge of the scattering sheet 6 than another first region projection 631 nearer the center portion of the scattering sheet 6, when viewed from the direction perpendicular to the second incidence surface 61. This enables an increase in luminous flux of light incident on part, adjacent to edges 2e, of a back surface of the display panel 2, with the light uniformly scattered. It is consequently possible to prevent occurrence of dark portions in the display panel 2 while uniforming luminance distribution of the display panel 2.

In the second embodiment, of first region projections 631 on the side of the one end of the scattering sheet 6 relative to the center portion of the scattering sheet 6, a vertex 63t of a first region projection 631 nearer the one end of the scattering sheet 6 is located further away from a center of the first region projection 631 to the side of the one end of the scattering sheet 6, when viewed from the direction perpendicular to the second incidence surface 61. It is therefore possible to uniform luminance distribution of the display panel 2.

In the present embodiment, the second region projections 632 are regular square pyramidal in shape. The embodiment therefore prevents a reduction in luminance flux of light incident on the center portion of the display panel 2. It is consequently possible to uniform luminance distribution of the display panel 2.

Note that although the first projections 63 are identical in height (h) in the second embodiment described above, the first projections 63 are not limited to being identical in height (h). FIG. 9 illustrates an additional example of the scattering sheet 6 in the second embodiment. As illustrated in FIG. 9, respective heights h of the first projections 63 may be increased from a center to a periphery of the scattering sheet 6. respective heights h may be increased at a constant rate. Alternatively, the respective heights h may be increased at random. Adjusting the respective heights h enables adjustment of light scattering directions.

Although the second region projections 632 are regular square pyramidal in shape in the second embodiment described above, the second region projections 632 are not limited to being regular square pyramidal in shape. The second region projections 632 may be oblique square pyramidal or quadrangular pyramidal. In this case, the second region projections 632 are formed so that relative locations of vertexes 63t thereof are arranged at random. This structure enables prevention of moire occurrence.

### Third Embodiment

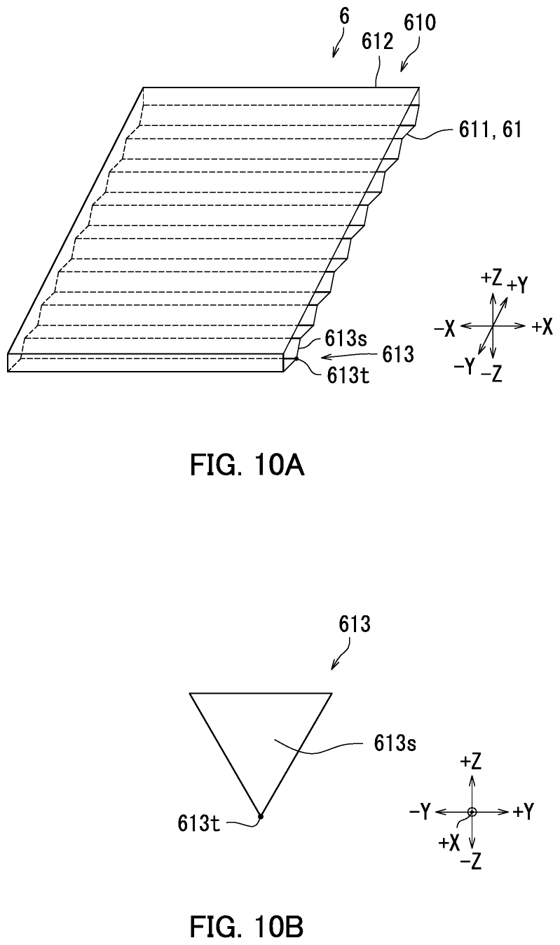

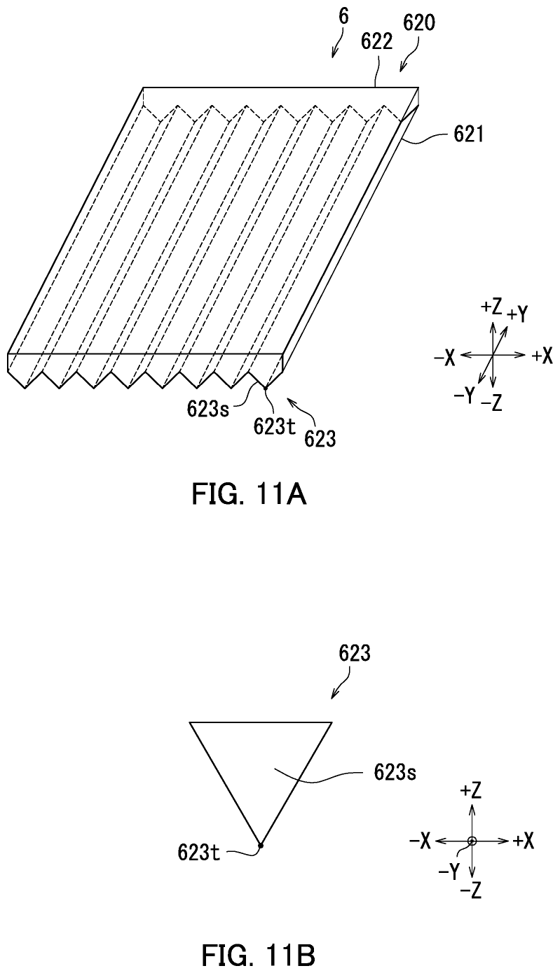

A display apparatus 100 according to a third embodiment will next be described with reference to FIGS. 10A to 11B. The third embodiment differs from the first and second embodiments in that a scattering sheet 6 is constituted by sheets. Elements different from those in the first and second embodiments will hereinafter be described in the third embodiment, and description overlapping with the first and second embodiments will be omitted.

In the third embodiment, the display apparatus 100 includes a first sheet 610 and a second sheet 620 that constitute the scattering sheet 6. The second sheet 620 is overlaid on the first sheet 610. Note that the first sheet 610 is one example of a first member, and the second sheet 620 is one example of a second member.

The first sheet 610 in the third embodiment will be described with reference to FIGS. 10A and 10B. FIG. 10A is a perspective view of one example of the first sheet 610 in the third embodiment. FIG. 10B illustrates a side face 613s of a first sheet projection 613 illustrated in FIG. 10A. Specifically, FIG. 10B depicts a first sheet projection 613 viewed from the +X side.

As illustrated in FIG. 10A, a main surface on the −Z side of the first sheet 610 is uneven. The first sheet 610 is for example a lens sheet.

The first sheet 610 has a first light-source-side surface 611 and a first panel-side surface 612. Here, the first light-source-side surface 611 is a surface of the first sheet 610 on a side of a light source section 4 (back side). The first panel-side surface 612 is a surface of the first sheet 610 on a side of a display panel 2 (front side). In the third embodiment, the first light-source-side surface 611 corresponds to a second incidence surface 61.

The first panel-side surface 612 is a main surface on the +Z side of the first sheet 610. The first light-source-side surface 611 is a main surface on the −Z side of the first sheet 610. First sheet projections 613 are formed on the first light-source-side surface 611. The first sheet projections 613 are one example of first member projections.

As illustrated in FIG. 10B, the first sheet projection 613 has a chevron shape as viewed in the X direction. The first sheet projection 613 is formed continuously in the X direction. That is, the first sheet projection 613 extends in the X direction. Light entered from the first light-source-side surface 611 is scattered in the Y direction. Note that the X direction is one example of a first direction.

The second sheet 620 in the third embodiment will next be described with reference to FIGS. 11A and 11B. FIG. 11A illustrates one example of the second sheet 620 in the third embodiment. FIG. 11B illustrates a side face 623s of a second sheet projection 623 illustrated in FIG. 11A. Specifically, FIG. 11B depicts the second sheet projection 623 viewed from the −Y side.

As illustrated in FIG. 11A, a main surface on −Z side of the second sheet 620 is uneven. The second sheet 620 is for example a lens sheet.

The second sheet 620 has a second light-source-side surface 621 and a second panel-side surface 622. Here, the second light-source-side surface 621 is a surface of the second sheet 620 on a side of the light source section 4 (back side). The second panel-side surface 622 is a surface of the second sheet 620 on a side of the display panel 2 (front side). The second panel-side surface 622 is a main surface on the +Z side of the second sheet 620. The second light-source-side surface 621 is a main surface on the −Z side of the second sheet 620. Second sheet projections 623 are formed on the second light-source-side surface 621. Note that the second panel-side surface 622 corresponds to a second exit surface 62. The second sheet projections 623 are one example of second member projections.

As illustrated in FIG. 11B, the second sheet projection 623 has a chevron shape as viewed in the Y direction. The second sheet projection 623 is formed continuously in the Y direction. That is, the second sheet projection 623 extends in a direction intersecting with (in the present embodiment, substantially perpendicular to) the direction in which the first sheet projections 613 extend. Light entered from the second light-source-side surface 621 is therefore scattered in the X direction. Note that the Y direction is one example of a second direction.

As above, the third embodiment has been described. In the third embodiment, the first sheet 610 and the second sheet 620 are overlaid on each other, thereby constituting the scattering sheet 6. This structure enables adjustment of light scattering directions by combining such different sheets.

In the third embodiment, a direction in which the first sheet projections 613 extend intersect with a direction in which the second sheet projections 623 extend. The first sheet projections 613 scatter light in the Y direction, while the second sheet projections 623 scatter light in the X direction. That is, the structure enables the first and second sheets 610 and 620 to scatter light in all directions. Thus, the embodiment prevents occurrence of dark portions in the display panel 2.

Note that although the second sheet 620 is overlaid on the first sheet 610 in the third embodiment described above, the first and second sheets 610 and 620 may be interchanged. In this case, the second light-source-side surface 621 corresponds to the second incidence surface 61, and the first panel-side surface 612 corresponds to the second exit surface 62.

Although the two sheets constitute the scattering sheet 6 in the third embodiment, three or more sheets overlaid on one another may constitute the scattering sheet 6.

### Fourth Embodiment

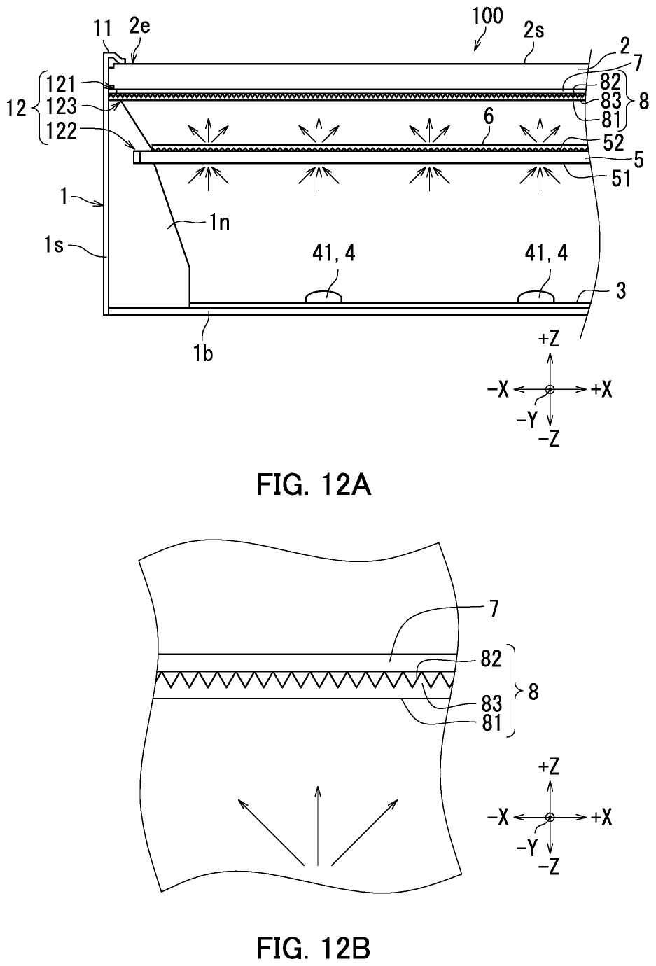

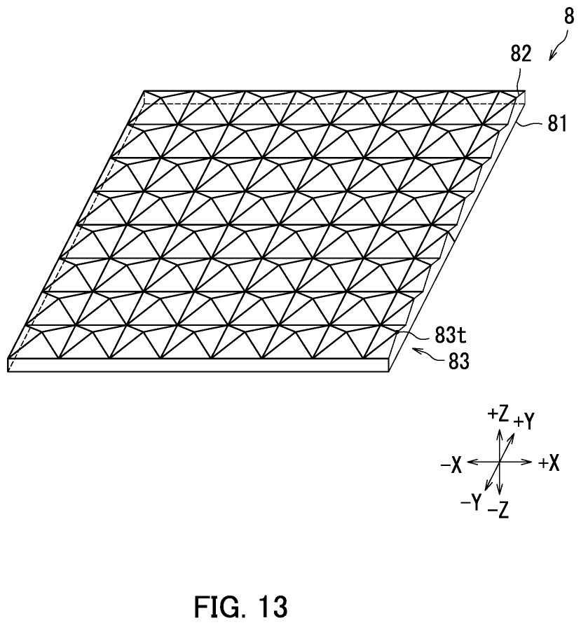

A display apparatus 100 according to a fourth embodiment will next be described with reference to FIGS. 12A to 13. The fourth embodiment differs from the first to third embodiments in that the display apparatus 100 according to the fourth embodiment further include a light collecting sheet 8. Elements different from those in the first to third embodiments will hereinafter be described in the fourth embodiment, and description overlapping with the first to third embodiments will be omitted.

FIG. 12A is a schematic diagram of main parts of the display apparatus 100 according to the fourth embodiment. Specifically, FIG. 12A is a sectional view of part of adjacent to an edge 2e on the −X side of the display apparatus 100, viewed from the −Y side. Hatching indicating a cross section of the display apparatus 100 is omitted for easy understanding in FIG. 12A. Each of arrows depicted in FIG. 12A represents part of a beam of light.

As illustrated in FIG. 12A, the display apparatus 100 further includes the light collecting sheet 8.

The light collecting sheet 8 is located between a scattering sheet 6 and an optical sheet 7. Specifically, the light collecting sheet 8 is located between the scattering sheet 6 and the optical sheet 7 with the light collecting sheet 8 located close to the optical sheet 7. That is, the light collecting sheet 8 is located nearer the display panel 2 than the scattering sheet 6.

The light collecting sheet 8 collects light scattered by the scattering sheet 6. A main surface of the light collecting sheet 8 on a side of a display panel 2 (+Z side—front side) is uneven. The light collecting sheet 8 is for example a lens sheet. Light entered from the light collecting sheet 8 is collected so that beams of light are arranged almost vertically (in a direction from the −Z side to the +Z side).

A support 12 further includes a third support portion 123. The third support portion 123 is located between a first support portion 121 and a second support portion 122. The third support portion 123 supports the light collecting sheet 8. For example, a cut formed in an inner wall 1n of the housing 1 functions as the third support portion 123. The light collecting sheet 8 is supported by the third support portion 123 as a result of an end on the −X side of the light collecting sheet 8 fitting into the cut.

A structure of the light collecting sheet 8 in the fourth embodiment will next be described with reference to FIG. 12B. FIG. 12B is an enlarged view in the vicinity of the light collecting sheet 8 illustrated in FIG. 12A. Note that each of arrows depicted in FIG. 12B represents part of a beam of light for easy understanding.

As illustrated in FIG. 12B, the light collecting sheet 8 has a third incidence surface 81 and a third exit surface 82.

The third incidence surface 81 allows light scattered by the scattering sheet 6 to be incident thereon. The third incidence surface 81 is constituted by a main surface on the −Z side of the light collecting sheet 8.

The third exit surface 82 is constituted by a main surface on the +Z side of the light collecting sheet 8. The light collecting sheet 8 allows the light entered from the third incidence surface 81 to exit from the third exit surface 82 with beams of the light collected. Specifically, the light collecting sheet 8 allows the light entered from the third incidence surface 81 to exit from the third exit surface 82 with beams of the light arranged almost vertically.

The third exit surface 82 has second projections 83. The second projections 83 refract light entered from the third incidence surface 81, thereby collecting light. Specifically, the second projections 83 collect light with beams of the light arranged vertically (in a direction from the −Z side to the +Z side). Note that an air layer is placed between the light collecting sheet 8 and the optical sheet 7.

A structure of the light collecting sheet 8 in the fourth embodiment will next be described with reference to FIG. 13. FIG. 13 is a perspective view of part of the light collecting sheet 8 in the fourth embodiment. Specifically, FIG. 13 depicts the light collecting sheet 8 cut in the Y direction. Note that hatching indicating a cross section of the light collecting sheet 8 is omitted in FIG. 13.

As illustrated in FIG. 13, the second projections 83 are regularly formed on the third exit surface 82 of the light collecting sheet 8. The second projections 83 are identical in shape. In the fourth embodiment, the second projections 83 are regular square pyramidal in shape.

As above, the fourth embodiment has been described. In the fourth embodiment, light scatted by the scattering sheet 6 is collected by the light collecting sheet 8. The embodiment therefore prevents a reduction in luminance flux of light traveling from the −Z side to the +Z side of light incident on the display panel 2. The embodiment consequently prevents a reduction in front luminance of the display panel 2. It is therefore possible to uniform luminance distribution of the display panel 2.

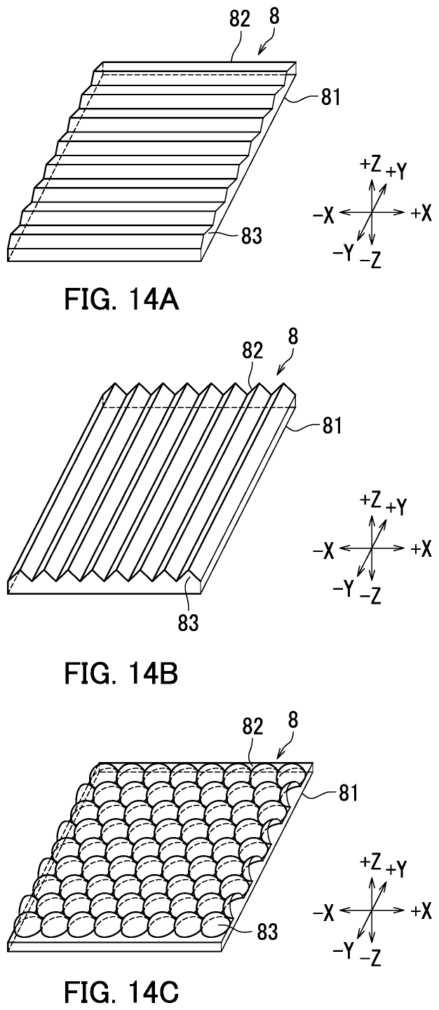

Note that although the second projections 83 are regular square pyramidal in shape in the fourth embodiment, the second projections 83 are not limited to being regular square pyramidal in shape. The second projections 83 may have a chevron shape as viewed in the X direction as illustrated in FIG. 14A, or a chevron shape as viewed in the Y direction as illustrated in FIG. 14B. Alternatively, the second projections 83 may be hemispherical in shape as illustrated in FIG. 14C. FIG. 14A is a perspective view of a first additional example of the light collecting sheet 8 in the fourth embodiment. FIG. 14B is a perspective view of a second additional example of the light collecting sheet 8 in the fourth embodiment. FIG. 14C is a perspective view of a third additional example of the light collecting sheet 8 in the fourth embodiment.

The light collecting sheet 8 may include light collecting sheets 8 overlaid on each other. For example, the light collecting sheet 8 may be constituted by the light collecting sheets 8 described with reference to FIGS. 14A and 14B overlaid on each other. The light collecting sheets 8 are overlaid with the third exit surface 82 located on the +Z side.

### Fifth Embodiment

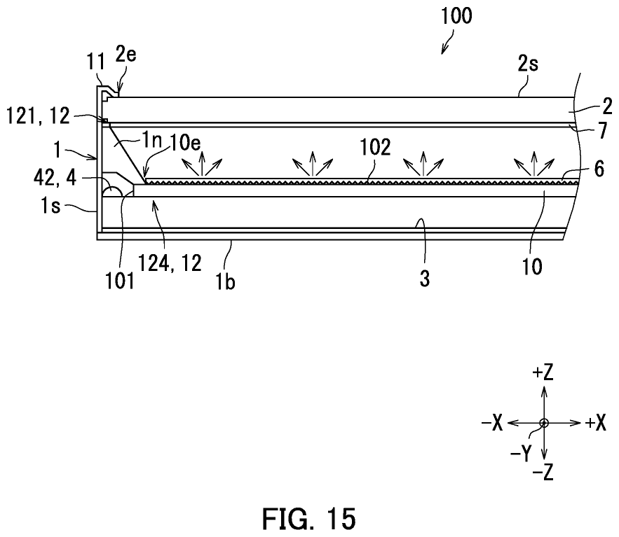

A display apparatus 100 according to a fifth embodiment will next be described with reference to FIG. 15. The fifth embodiment differs from the first to fourth embodiments in that the display apparatus 100 according to the fifth embodiment belongs to an edge light type backlight system. Elements different from those in the first to fourth embodiments will hereinafter be described in the fifth embodiment, and description overlapping with the first to fourth embodiments will be omitted.

In the fifth embodiment, a structure in the vicinity of an edge 2e on the +X side of the display apparatus 100 is identical to a structure in the vicinity of an edge 2e on the −X side thereof. A structure in the vicinity of an edge 2e on the −Y side of the display apparatus 100 and a structure in the vicinity of an edge 2e on the +Y side thereof are identical to the structure in the vicinity of the edge 2e on the −X side except that second light sources 42 are omitted. Therefore, the structure in the vicinity of the edge 2e on the −X side of the display apparatus 100 will be described with reference to FIG. 15, and a description of respective structures in the vicinity of the edges 2e on the −X side, the −Y side, and the +Y side will be omitted.

FIG. 15 is a schematic diagram of main parts of the display apparatus 100 according to the fifth embodiment. Specifically, FIG. 15 is a sectional view in the vicinity of the edge 2e on the −X side of the display apparatus 100, viewed from the −Y side. Hatching indicating a cross section of the display apparatus 100 is omitted for easy understanding in FIG. 15. Each of arrows depicted in FIG. 15 represents part of a beam of light.

As illustrated in FIG. 15, the display apparatus 100 includes a light guide plate 10 in place of a diffusion plate 5. A light source section 4 includes second light sources 42 on the −X side in place of first light sources 41. The second light sources 42 are placed in a space between a side wall 1s and an inner wall 1n of a housing 1. The second light sources 42 are constituted by for example LEDs.

In the fifth embodiment, a support 12 includes a fourth support portion 124. Within the housing 1, the fourth support portion 124 is provided on the −Z side relative to a first support portion 121 and the +X side relative to the first support portion 121. Note that a second support portion 122 is omitted.

The fourth support portion 124 supports the light guide plate 10. For example, a cut formed in the inner wall 1n of the housing 1 functions as the fourth support portion 124. The light guide plate 10 is supported by the fourth support portion 124 as a result of an end on the −X side of the light guide plate 10 fitting into the cut. Of the light guide plate 10, portion except part fitting into the cut of the fourth support portion 124 will hereinafter be referred to as an “exposed portion”.

The light guide plate 10 guides light emitted from the second light source 42 to a light-guide exit surface 102 to be described later. An external shape of the light guide plate 10 corresponds to an external shape of a display panel 2. In the present embodiment, the light guide plate 10 is rectangular in plan view.

External dimensions of the light guide plate 10 (exposed portion thereof) are smaller than external dimensions of the display panel 2 (display area 2s). A length of the light guide plate 10 (exposed portion thereof) in the X direction is smaller by a third distance than a length of the display area 2s in the X direction. The third distance is for example a sum of a distance x3 and a distance x4. The distance x3 is a distance between the edge 2e on the −X side of the display area 2s and an edge 10e on the −X side of the exposed portion of the light guide plate 10. The distance x4 is a distance between the edge 2e on the +X side of the display area 2s and an edge 10e on the +X side of the exposed portion of the light guide plate 10. The distance x3 may be equal to or different from the distance x4. The edges 10e of the exposed portion of the light guide plate 10 represent a boundary between the light guide plate 10 and the fourth support portion 124. The third distance is for example 8 mm.

A length of the light guide plate 10 (exposed portion thereof) in the Y direction is smaller by a fourth distance than a length of the display area 2s in the Y direction. The fourth distance is for example a sum of a distance y3 and a distance y4. The distance y3 is a distance between the edge 2e on the −Y side of the display area 2s and an edge 10e on the −Y side of the exposed portion of the light guide plate 10. The distance y4 is a distance between the edge 2e on the +Y side of the display area 2s and an edge 10e on the +Y side of the exposed portion of the light guide plate 10. The distance y3 may be equal to or different from the distance y4. The fourth distance is for example 8 mm. Note that the fourth distance may be equal to or different from the third distance.

The light guide plate 10 has a light-guide incidence surface 101 and the light-guide exit surface 102. The light-guide incidence surface 101 allows light exiting the second light sources 42 to be incident thereon. The light-guide incidence surface 101 is constituted by an end face of the light guide plate 10 on a side of the second light source 42 (−X side).

The light entered from the light-guide incidence surface 101 exits from the light-guide exit surface 102. The light-guide exit surface 102 is constituted by a main surface on the +Z side of the light guide plate 10. As stated above, the external dimensions of the light guide plate 10 are smaller than the external dimensions of the display area 2s of the display panel 2. External dimensions of the light-guide exit surface 102 are therefore smaller than external dimensions of the display area 2s.

A scattering sheet 6 is located between the display panel 2 and the light guide plate 10. Specifically, the scattering sheet 6 is located nearer the light guide plate 10 than the display panel 2 in the Z direction. In the present embodiment, the scattering sheet 6 is disposed on the light guide plate 10. Note that an air layer is provided between the scattering sheet 6 and the light guide plate 10.

The scattering sheet 6 scatters light exiting the light guide plate 10.

As above, the fifth embodiment has been described. In the fifth embodiment, light exiting the light-guide exit surface 102 of the light guide plate 10 is scattered by the scattering sheet 6. The embodiment accordingly prevents a reduction in luminance near the edges 2e of the display area 2s. Thus, the embodiment prevents occurrence of dark portions near the edges 2e of the display area 2s.

For example, when display apparatuses 100 are arranged to be used as a multi monitor, it may be felt that four corners of a display apparatus 100 surrounded by adjoining display apparatuses 100 are dark. The above structure of the display apparatus 100 however prevents a reduction in luminance near the edges 2e of the display area 2s. Therefore, the embodiment suppresses, even when display apparatuses 100 are used as a multi monitor, dark feeling at four corners of a display apparatus 100 surrounded by adjoining display apparatuses 100.

Note that although the display apparatus described in the fifth embodiment includes the second light sources 42 in the vicinity of the edges 2e on the −X side and the +X side with second light sources 42 in the vicinity of the edges 2e on the −Y side and the +Y side omitted, locations of the second light sources 42 are not limited to the locations in the vicinity of the edges 2e on the −X side and the +X side. The display apparatus 100 may include second light sources 42 in the vicinity of the edges 2e on the −Y side and the +Y side. The display apparatus 100 needs to include second light sources 42 in the vicinity of at least one of the edges 2e on the +X side, the −X side, the +Y side, and the −Y side. For example, the display apparatus 100 may include the second light sources 42 in the vicinity of each of the edges 2e on the +X side, the −X side, the +Y side, and the −Y side.

The embodiments of the present disclosure have been described above with reference to the accompany drawings (FIGS. 1 to 15). However, the present disclosure is not limited to the above-described embodiments and can be practiced in various ways within the scope without departing from the essence of the present disclosure. Further, the structures, material, numerical values, and the like described in the above embodiments are merely examples that do not impose any particular limitations and may be altered in various ways as long as such alterations do not substantially deviate from the effects of the present disclosure.

For example, although the first and second light sources 41 include LEDs, the first and second light sources 41 are not limited to the LEDs. The first and second light sources 41 need to emit light, and therefore may include fluorescent tubes.

The present application further discloses appendices below. Note that the present disclosure is not limited to the appendices below.

### APPENDIX 1

A display apparatus includes:

a light source configured to emit light;

a diffusion plate configured to diffuse the light emitted from the light source;

a display panel with a display area, the diffusion plate and the display panel being spaced apart; and

a scattering member located between the display panel and the diffusion plate with the scattering member located nearer the diffusion plate than the display panel, wherein

the diffusion plate includes:
a first incidence surface that allows the light emitted from the light source to be incident thereon; and
a first exit surface that is smaller than the display area,

the diffusion plate allows the light entered from the first incidence surface to exit from the first exit surface with the light diffused, and

the scattering member allows the light exited from the first exit surface to pass therethrough with the light passing therethrough scattered.

### APPENDIX 2

In the display apparatus according to Appendix 1,

the scattering member includes:
a second incidence surface that allows the light exiting the first exit surface to be incident thereon; and
a second exit surface,

the second incidence surface includes projections, and

the scattering member allows the light entered from the second incidence surface to exit from the second exit surface with the light scattered by the projections.

### APPENDIX 3

In the display apparatus according to Appendix 2,

the projections are quadrangular pyramidal in shape.

### APPENDIX 4

In a display apparatus according to Appendix 2 or 3,

the projections are formed so that respective vertexes of the projections are arranged at random.

### APPENDIX 5

In a display apparatus according to Appendix 2 or 3,

the second incidence surface includes a first region that is a region of an outer portion of the scattering member,

the projections include first region projections formed in the first region, and

of the first region projections, a vertex of a first region projection near an edge of the scattering member is located further away from a center of the first region projection toward the edge of the scattering member than another first region projection near a center portion of the scattering member when viewed from a direction perpendicular to the second incidence surface.

### APPENDIX 6

In the display apparatus according to Appendix 5,

the second incidence surface includes a second region different from the first region,

the projections include second region projections that are projections formed in the second region, and

the second region projections are formed so that respective vertexes of the second region projections are arranged at random.

### APPENDIX 7

In the display apparatus according to Appendix 2,

each of the projections is hemispherical in shape.

### APPENDIX 8

In a display apparatus according to any one of Appendices 1 to 7,

the scattering member includes a first member and a second member overlaid on the first member,

the first member has a first light-source-side surface that is a surface of the first member on a side of the light source, and a first panel-side surface that is a surface of the first member on a side of the display panel, and

the second member includes a second light-source-side surface that is a surface of the second member on the side of the light source, and a second panel-side surface that is a surface of the second member on the side of the display panel.

### APPENDIX 9

In the display apparatus according to Appendix 8,

the first light-source-side surface corresponds to the second incidence surface,

the second panel-side surface corresponds to the second exit surface,

the first light-source-side surface includes the first member projections,

the second light-source-side surface includes the second member projections,

the first member projections extend in a first direction,

the second member projections extend in a second direction intersecting with the first direction, and

the first member projections correspond to the projections.

### APPENDIX 10

A display apparatus according to any one of Appendices 1 to 9 further includes

a light collecting member located between the display panel and the scattering member with the light collecting member located nearer the display panel than the scattering member, wherein

the light collecting member is configured to collect the light scattered by the scattering member.

### APPENDIX 11

A display apparatus includes:

a light source configured to emit light;

a light guide plate configured to guide the light emitted from the light source;

a display panel with a display area, the light guide plate and the display panel being spaced apart; and

a scattering member located between the display panel and the light guide plate with the scattering member located nearer the light guide plate than the display panel, wherein

the light guide plate includes:
a light-guide incidence surface that is an incidence surface of the light guide plate and that allows the light emitted from the light source to be incident thereon; and
a light-guide exit surface that is an exit surface of the light guide plate and that is smaller than the display area,

the light guide plate allows the light entered from the light-guide incidence surface to exit from the light-guide exit surface, and

the scattering member allows the light exited from the light-guide exit surface to pass therethrough with the light passing therethrough scattered.

What is claimed is:

1. A display apparatus, comprising:
a light source configured to emit light;
a diffusion plate configured to diffuse the light emitted from the light source;
a display panel with a display area, the diffusion plate and the display panel being spaced apart; and
a scattering member located between the display panel and the diffusion plate with the scattering member located nearer the diffusion plate than the display panel, wherein
the diffusion plate includes:
a first incidence surface that allows the light emitted from the light source to be incident thereon; and
a first exit surface that is smaller than the display area,
the diffusion plate allows the light entered from the first incidence surface to exit from the first exit surface with the light diffused, and
the scattering member allows the light exited from the first exit surface to pass therethrough with the light passing therethrough scattered.

2. The display apparatus according to claim 1, wherein
the scattering member includes:
a second incidence surface that allows the light exiting the first exit surface to be incident thereon; and
a second exit surface,
the second incidence surface includes projections, and
the scattering member allowing the light entered from the second incidence surface to exit from the second exit surface with the light scattered by the projections.

3. The display apparatus according to claim 2, wherein
the projections are quadrangular pyramidal in shape.

4. The display apparatus according to claim 3, wherein
the projections are formed so that respective vertexes of the projections are arranged at random.

5. The display apparatus according to claim 3, wherein
the second incidence surface includes a first region that is a region of an outer portion of the scattering member,
the projections include first region projections that are projections formed on the first region, and
of the first region projections, a vertex of a first region projection near an edge of the scattering member is located further away from a center of the first region projection toward the edge of the scattering member than another first region projection near a center portion of the scattering member when viewed from a direction perpendicular to the second incidence surface.

6. The display apparatus according to claim 5, wherein
the second incidence surface includes a second region different from the first region,
the projections include second region projections that are projections formed in the second region, and
the second region projections are formed so that respective vertexes of the second region projections are arranged at random.

7. The display apparatus according to claim 2, wherein
each of the projections is hemispherical in shape.

8. The display apparatus according to claim 2, wherein
the scattering member includes a first member and a second member overlaid on the first member,
the first member has a first light-source-side surface that is a surface of the first member on a side of the light source, and a first panel-side surface that is a surface of the first member on a side of the display panel, and
the second member has a second light-source-side surface that is a surface of the second member on the side of the light source, and a second panel-side surface that is a surface of the second member on the side of the display panel.

9. The display apparatus according to claim 8, wherein
the first light-source-side surface corresponds to the second incidence surface,
the second panel-side surface corresponds to the second exit surface,
the first light-source-side surface includes the first member projections,
the second light-source-side surface includes the second member projections,
the first member projections extend in a first direction,
the second member projections extend in a second direction intersecting with the first direction, and
the first member projections correspond to the projections.

10. The display apparatus according to claim 1, further comprising
a light collecting member located between the display panel and the scattering member with the light collecting member located nearer the display panel than the scattering member, wherein
the light collecting member is configured to collect the light scattered by the scattering member.

11. A display apparatus, comprising:
a light source configured to emit light;
a light guide plate configured to guide the light emitted from the light source;
a display panel with a display area, the light guide plate and the display panel being spaced apart; and
a scattering member located between the display panel and the light guide plate with the scattering member located nearer the light guide plate than the display panel, wherein
the light guide plate includes:
a light-guide incidence surface that is an incidence surface of the light guide plate and that allows the light emitted from the light source to be incident thereon; and
a light-guide exit surface that is an exit surface of the light guide plate and that is smaller than the display area,
the light guide plate allows the light entered from the light-guide incidence surface to exit from the light-guide exit surface, and
the scattering member allows the light exited from the light-guide exit surface to pass therethrough with the light passing therethrough scattered.
